(19) United States
(12) Patent Application Publication
(10) Pub. No.: US 2021/0192435 A1
(43) Pub. Date: Jun. 24, 2021

(54) SYSTEMS AND METHODS FOR SAFETY STOCK OPTIMIZATION FOR PRODUCTS STOCKED AT RETAIL FACILITIES

(71) Applicant: Walmart Apollo, LLC, Bentonville, AR (US)

(72) Inventors: Savio F. Fernandes, North Goa (IN); Aloka Sudhodanan, Palakkad (IN)

(21) Appl. No.: 17/114,848

(22) Filed: Dec. 8, 2020

Related U.S. Application Data
(60) Provisional application No. 62/951,977, filed on Dec. 20, 2019.

(51) Int. Cl. G06Q 10/08; G06Q 30/02; G06N 7/00

(52) U.S. Cl. CPC G06Q 10/087; G06N 7/005; G06Q 30/0202

(57) ABSTRACT

Systems and methods for calculating the safety stock of a product at a retail facility to reduce out-of-stock events and excess inventory build-up for the product at the retail facility include at least one electronic database configured to store electronic data that comprises historical lead time data, historical demand forecast data, historical sales data, and order-related data associated with the product. A computing device includes a demand variability generator configured to analyze the electronic data obtained from the electronic database to determine an estimated demand variability value with respect to the product, a lead time variability generator configured to analyze the electronic data obtained from the electronic database to determine an estimated actual lead time value with respect to the product; and a safety stock generator configured to correlate the estimated demand variability value and the estimated actual lead time value to determine an estimated safety stock value with respect to the product at the retail facility.

### CROSS-REFERENCE TO RELATED APPLICATION

This application claims the benefit of U.S. Provisional Application No. 62/951,977, filed Dec. 20, 2019, which is incorporated herein by reference in its entirety.

### TECHNICAL FIELD

This invention relates generally to managing inventory at retail facilities and, in particular, to calculating a safety stock for products at a retail facility to reduce out-of-stock events and build-up of excess inventory for the products at the retail facility.

### BACKGROUND

A retail facility typically calculates safety stock (i.e., extra stock) for the products they stock in inventory in order to mitigate risk of stockouts of products at the retail facility that may be caused by uncertainties in supply and demand. Generally speaking, inventory stock depends essentially on two factors: demand, i.e., the number of items that will be consumed or bought by consumers at the retail facility, and lead time, i.e., the delay between reorder decision and renewed availability. The conventional approach for calculating safety stock is to model the lead time and demand variability components which are then used to calculate the requisite Safety stock value on a product/store/day level.

Each of these factors is subject to uncertainties, which may result in inaccuracies in inventory stock calculation, which may undesirably lead to stockouts (situations when the item sells out at the retail facility, such that the consumers are still looking to buy the item at the retail facility (i.e., there is still consumer demand), but the retail facility does not have the item in stock on the sales floor or in the stock room)). In addition, it is conventional for retail facilities not to capture or monitor historical safety stock data and there is currently no effective metric to monitor safety stock estimation effectiveness.

### BRIEF DESCRIPTION OF THE DRAWINGS

Disclosed herein are embodiments of systems, apparatuses, and methods pertaining to calculating a safety stock of at least one product at a retail facility to reduce out-of-stock events for the at least one product at the retail facility. This description includes drawings, wherein:

FIG. 1 is a diagram of a system of calculating a safety stock of at least one product at a retail facility to reduce out-of-stock events for the at least one product at the retail facility in accordance with some embodiments.

FIG. 2 is a functional diagram of the computing device of FIG. 1 in accordance with several embodiments.

FIG. 3 is an exemplary system diagram illustrating various components/sub-databases that may be included in the system of FIG. 1 in accordance with some embodiments.

FIG. 4 is a diagram representing an overview flow chart of an exemplary process of calculating a safety stock of at least one product at a retail facility in accordance with some embodiments.

FIG. 5 is a diagram representing a more detailed flow chart of an exemplary process of calculating a safety stock of at least one product at a retail facility in accordance with some embodiments.

FIG. 6 is a flow chart diagram of a method of calculating a safety stock of at least one product at a retail facility to reduce out-of-stock events for the at least one product at the retail facility in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Generally speaking, this disclosure relates to systems and methods for calculating a safety stock of at least one product at a retail facility to reduce out-of-stock events for the at least one product at the retail facility. The systems and methods include at least one electronic database configured to store electronic data that comprises historical lead time data associated with the at least one product, historical demand forecast data associated with the at least one product, historical sales data associated with the at least one product, and order-related data associated with the at least one product. A computing device includes a demand variability generator configured to analyze the electronic data obtained from the at least one electronic database to determine an estimated demand variability value with respect to the at least one product; a lead time variability generator configured to analyze the electronic data obtained from the at least one electronic database to determine an estimated actual lead time value with respect to the at least one product; and a safety stock generator configured to correlate the estimated demand variability value and the estimated actual lead time value to determine an estimated safety stock value with respect to the at least one product. As compared to the conventional way of assuming the normality distribution of demand curve and looking at handling the variance of such demand, the systems/methods described herein make the safety stock calculation more dynamic and future-looking by using machine learning and algorithmic approaches.

In some embodiments, a system for calculating a safety stock of at least one product at a retail facility to reduce out-of-stock events for the at least one product at the retail facility includes: at least one electronic database configured to store electronic data that comprises historical lead time data associated with the at least one product, historical demand forecast data associated with the at least one product, historical sales data associated with the at least one product, and order-related data associated with the at least one product, as well as a computing device including an electronic display and a control unit having a programmable processor and configured to cause the computing device to obtain the electronic data from the at least one database. The computing device includes: a demand variability generator configured to analyze the electronic data obtained from the at least one electronic database to determine an estimated demand variability value with respect to the at least one product; a lead time variability generator configured to analyze the electronic data obtained from the at least one electronic database to determine an estimated actual lead time value with respect to the at least one product; and a safety stock generator configured to correlate the estimated demand variability value and the estimated actual lead time value to determine an estimated safety stock value with respect to the at least one product. The processor of the control unit is programmed to generate a signal configured to generate, on the electronic display of the computing device, a graphical interface including: an indication of the estimated safety stock value with respect to the at least one product; and a graphical element permitting a user of the computing device to order a number of units of the at least one product corresponding to the estimated safety stock value displayed in the graphical interface.

In some embodiments, a method of calculating a safety stock of at least one product at a retail facility to reduce out-of-stock events for the at least one product at the retail facility includes: providing at least one electronic database configured to store electronic data that comprises historical lead time data associated with the at least one product, historical demand forecast data associated with the at least one product, historical sales data associated with the at least one product, and order-related data associated with the at least one product; providing a computing device including an electronic display and a control unit having a programmable processor, the control unit configured to cause the computing device to obtain the electronic data from the at least one database, wherein the computing device includes a demand variability generator, a lead time variability generator, and a safety stock generator; analyzing, via the demand variability generator, the electronic data obtained from the at least one electronic database to determine an estimated demand variability value with respect to the at least one product; analyzing, via the lead time variability generator, the electronic data obtained from the at least one electronic database to determine an estimated actual lead time value with respect to the at least one product; and correlating, via the safety stock generator, the estimated demand variability value and the estimated actual lead time value to determine an estimated safety stock value with respect to the at least one product; and generating, via the processor of the control unit, a signal configured to generate, on the electronic display of the computing device, a graphical interface including: an indication of the estimated safety stock value with respect to the at least one product; and a graphical element permitting a user of the computing device to order a number of units of the at least one product corresponding to the estimated safety stock value displayed in the graphical interface.

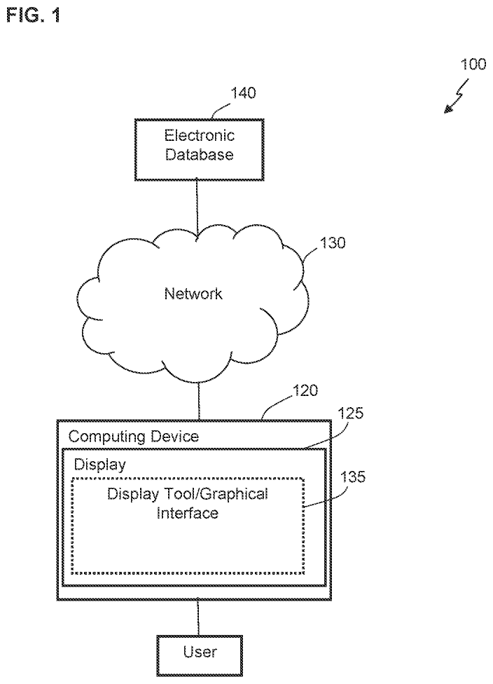

FIG. 1 illustrates one embodiment of a system 100 for calculating a safety stock of at least one product at a retail facility to reduce out-of-stock events for the at least one product at the retail facility 110. The retail facility 110 may be any place of business such as a store, warehouse, distribution center, or the like, where consumer products are sold and/or stocked.

The system 100 includes a computing device 120 configured to manage product inventory at the retail facility 110 operated by a retail provider. The computing device 120 illustrated in FIG. 1 may be a stationary, portable, or hand-held electronic device (or a combination of one or more such electronic devices), for example, a desktop computer, a laptop computer, a tablet, a mobile phone, or any other device that may be configured for data entry and communication with another device located at the retail facility 110, or at a location remote to the retail facility 110 (e.g., a regional or central server configured for two-way communication with multiple retail facilities 110). While the computing device 120 has been illustrated as being located within the confines of the retail facility 110, it will be appreciated that the computing device 120 may be located at a location remote to the retail facility 110 (e.g., at a facility operated by or for the retail provider).

In the embodiment illustrated in FIG. 1, the computing device 120 is configured to communicate with various electronic device (e.g., electronic database 140, portable electronic device of a worker at a retail facility, etc.) via a network 130. The exemplary network 130 depicted in FIG. 1 may be a wide-area network (WAN), a local area network (LAN), a personal area network (PAN), a wireless local area network (WLAN), or any other internet or intranet network, or combinations of such networks. Generally, communication between various electronic devices of system 100 may take place over hard-wired, wireless, cellular, Wi-Fi or Bluetooth networked components or the like. In some embodiments, one or more electronic devices of system 100 may include cloud-based features, such as cloud-based memory storage.

The exemplary system 100 depicted in FIG. 1 includes an electronic database 140. The electronic database 140 may be stored, for example, on non-volatile storage media (e.g., a hard drive, flash drive, or removable optical disk) internal or external relative to the computing device 120 or internal to computing devices (e.g., remote server) separate and distinct from the computing device 120.

In some embodiments, the electronic database 140 stores electronic data that comprises historical lead time data associated with products stocked at the retail facility 110, historical demand forecast data associated with the products stocked at the retail facility 110, historical sales data associated with the products stocked at the retail facility 110, and order-related data associated with the product stocked at the retail facility 110. In certain implementations, the electronic database 140 also stores actual demand distribution data.

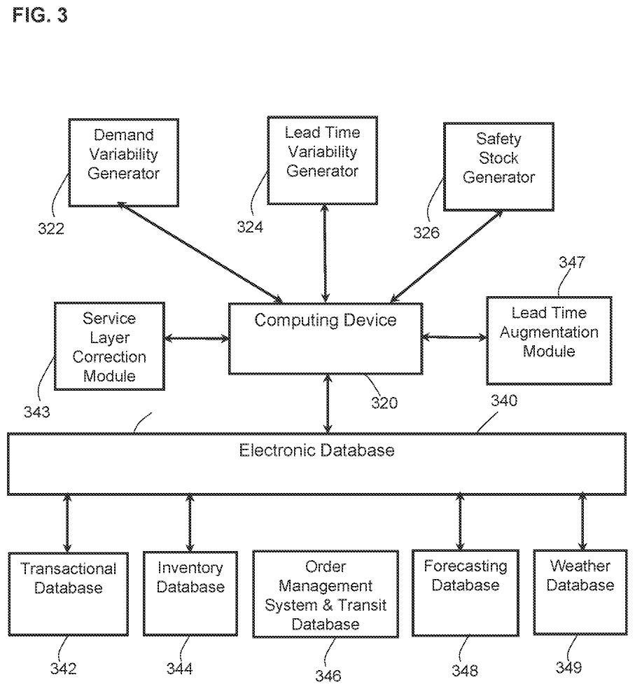

While the electronic database 140 is shown in FIG. 1 as a single database, it will be appreciated that the electronic database 140 can be implemented as a plurality of interconnected databases. In certain implementations, the system 100 includes a data aggregation module configured to obtain electronic data (e.g., historical lead time data, historical forecast data, historical sales data, product order-related data pertaining to the retail facility 110, etc.) from a plurality of electronic databases (e.g., the exemplary electronic databases 342, 344, 346, 348, and 349 illustrated in FIG. 3). In some aspects, the data aggregation system is a Hadoop system.

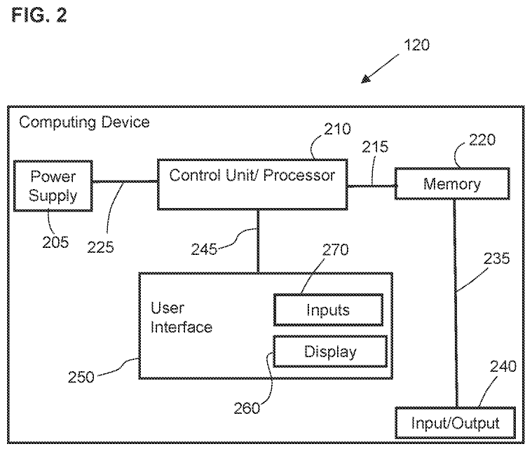

With reference to FIG. 2, an exemplary computing device 120 configured for use with exemplary systems and methods described herein may include a control circuit or control unit 210 including a processor (for example, a microprocessor or a microcontroller) electrically coupled via a connection 215 to a memory 220 and via a connection 225 to a power supply 205. The control unit 210 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control unit 210 can be configured (for example, by using corresponding programming stored in the memory 220 as will be well understood by those skilled in the art) to carry out one or more of the steps, actions, and/or functions described herein. In some embodiments, the memory 220 may be integral to the processor-based control unit 210 or can be physically discrete (in whole or in part) from the control unit 210 and is configured non-transitorily store the computer instructions that, when executed by the control unit 210, cause the control unit 210 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control unit may be referred to as a non-transitory medium or non-transitory computer readable medium.

The control unit 210 of the computing device 120 is also electrically coupled via a connection 235 to an input/output 240 that can receive signals from the computing device 120, or from any other source that can communicate with the computing device 120 via the network 130. The input/output 240 of the computing device 120 can also send signals to the electronic database 140 and/or to any other device in wired or wireless communication with the computing device 120 over the network 130 or any other communication channel.

In the embodiment shown in FIG. 2, the processor-based control unit 210 of the computing device 120 is electrically coupled via a connection 245 to a user interface 250, which may include a visual display or display screen 260 (e.g., light-emitting-diode (LED) screen) and/or button input 270 that provide the user interface 250 with the ability to permit an operator of the computing device 120 to manually control the computing device 120 by inputting commands via touch-screen and/or button operation and/or voice commands. It will be appreciated that the performance of such functions by the processor-based control unit 210 of the computing device 120 is not dependent on a human operator, and that the control unit 210 may be programmed to perform such functions without a human operator.

In some embodiments, the display screen 260 of the computing device 120 is configured to display various graphical interface-based menus, options, and/or alerts that may be transmitted from the computing device 120 to, and displayed on, the computing device 120 in connection with various aspects of calculating a safety stock for one or more items at the retail facility 110. The inputs 270 of the computing device 120 may be configured to permit an operator to navigate through the on-screen menus on the computing device 120 and make changes and/or updates to the safety stock estimations and/or calculations by the control circuit 210. It will be appreciated that the display screen 260 may be configured as both a display screen and an input 270 (e.g., a touchscreen that permits an operator to press on the display screen 260 to enter text and/or execute commands.)

In an exemplary embodiment illustrated in FIG. 3, the electronic database 140 includes or is coupled to a transactional database 342. In some aspects, the transactional database 342 stores electronic data relating to in-store purchase transactions generated at Point-of-Sale terminals of the retail facility 110 operated by the retail provider and online purchase transactions made over order processing server(s) operated by or for the retail provider. In some embodiments, the transactional database 342 stores electronic data representing store number, product number department description, item cost, sale price, quantity, sales amount, etc. In some aspects, the transactional database 342 is a Teradata® database system.

The exemplary electronic database 140 of FIG. 3 further includes or is coupled to an inventory database 344. In some aspects, the inventory database 344 stores electronic data relating to perpetual inventory of products at the retail facility 110. In some embodiments, the inventory database 344 stores electronic data representing product number, store number, inventory level at end of day at retail facility 110, quantity of items in transit to the retail facility 110, quantity of items in warehouse associated with the retail facility 110, quantity of items ordered from the retail facility 110 within a given interval of time, quantity of pending orders, etc.

The electronic database 140 of FIG. 3 further includes or is coupled to an order management system & transit (OMST) database 346. In some aspects, the OMST database 346 stores electronic data relating to pending orders (e.g., orders by the retail facility 110 to a distribution center and/or orders by consumers at retail facility 110), as well as delivery of products to retail facility 110 (e.g., form distribution center) or from retail facility 110 (e.g., to a home of a customer of the retail facility 110). In some embodiments, the OMST database 346 stores electronic data representing invoice date, ship to store number, product number, purchase order number, load identification (ID), trip ID, shipment ID, channel ID, customer service level, etc.

The exemplary electronic database 140 of FIG. 3 further includes or is coupled to a forecasting database 348. In some aspects, the transactional database 342 is a Teradata® database system. The forecasting database 348 may be configured to store electronic data representing date, product number, store number, forecasted quantity, etc.

In an exemplary embodiment illustrated in FIG. 3, the electronic database 140 includes or is coupled to a weather database 349. In some aspects, the weather database 349 stores electronic data relating to weather in the area where the retail facility 110 is located. In some embodiments, the weather database 349 stores electronic data representing store number, latitude & longitude of the store, min, max & average temperature, precipitation quantity, snowfall quantity, observation date, etc.

As will be described in more detail below, in some embodiments, the control unit 210 of the computing device 120 is programmed to obtain electronic data from the electronic database 140 over the network 130 and to analyze the electronic data obtained by the computing device 120 from the electronic database in order to determine an estimated safety stock value with respect to one or more products in stock at the retail facility 110. In some aspects, the processor of the control unit 210 is programmed to generate a signal that is configured to generate, on the electronic display 125 of the computing device 120, a graphical interface 135 including: an indication of the estimated safety stock value with respect to one or more products in inventory at the retail facility 110; and a graphical element permitting a user of the computing device 120 to order a number of units of the product corresponding to the estimated safety stock value displayed in the graphical interface 135.

In some embodiments, the computing device 320 includes or is coupled to one or more generator units/engines/modules that facilitate this calculation. In the exemplary embodiment shown in FIG. 3, the computing device 320 is coupled to a demand variability generator 322, lead time variability generator 324, safety stock generator 326, service level correction module 343, and lead time augmentation module 347. It will be appreciated that these generators and modules have been shown by way of illustration only, and that the computing device 320 may be implemented to incorporated or to be coupled to less or more generators/modules/engines than shown in FIG. 3. The function and interaction of the generators 322, 324, and 326 is described in more detail below. For example, in some embodiments, the demand variability generator 322 transmits the determined estimated demand variability value with respect to the product to the electronic database 140, and the lead time variability generator 324 transmits the determined estimated actual lead time with respect to the product to the electronic database 140; and the safety stock generator 326 obtains the estimated demand variability value and the estimated actual lead time from the electronic database 140.

With reference to FIG. 3, in some embodiments, the computing device 120 includes or is coupled to a demand variability generator 322. The exemplary demand variability generator 322 is configured to analyze the electronic data obtained from the electronic database 140 to determine an estimated demand variability value with respect to a product of interest that is in stock at the retail facility 110.

In some aspects, the demand variability generator 322 is programmed to perform one or more of the following functions: calculate a historical forecast lead time forecast error for a given interval of time (e.g., 30 days, 60 days, 90 days, etc.); predict the lead time forecast error for the future using time series techniques; adjust the service level based on normality correction; and calculate safety stock coverage (SSCOV). Generally, the demand variability generator 322 is configured to predict the demand forecast error (e.g., historical product sales—historical product forecast), considering the past and any foreseeable future conditions such as promotions, weather, etc. In some aspects, techniques such as simple exponential smoothing and autoregressive integrated moving average (ARIMA)/seasonal ARIMA (SARIMA) are used to determine the demand forecast error of the future.

In some implementations, the demand variability generator 322 correlates the historical demand forecast data associated with the product and the historical sales data associated with the product, and estimates a demand forecast error associated with the product. In certain embodiments, the demand variability generator 322 analyzes the historical demand forecast data to determine the estimated demand variability value with respect to the product based on a simple exponential smoothing model and/or an autoregressive integrated moving average (ARIMA) model. In addition, in certain aspects, the demand variability generator 322 selects the estimated demand variability value derived via the simple exponential smoothing model or the estimated demand variability value derived via the autoregressive integrated moving average (ARIMA) model based on estimated accuracy of the selected model. In some aspects, in order to perform the best model selection for a given product being analyzed, the demand variability generator 322 runs a model for the historical data, where the actual lead times and demand are known. This model gives the lowest error for that product and is interpreted by the demand variability generator 322 to be the best model for the analyzed product.

In the embodiment of FIG. 3, the computing device 120 also includes or is coupled to a lead time variability generator 324. The lead time variability generator 324 is configured to analyze the electronic data obtained from the at least one electronic database to determine an estimated actual lead time value with respect to the product. In some aspects, the lead time variability generator 324 is programmed to perform one or more of the following functions: calculate a historical lead time for a given interval of time (e.g., 1 year, 2 year, 3 years, etc.) of orders using various dates recorded in the order cycle; predict the lead time for future orders using a probabilistic approach; predict lead time for future orders using a machine learning model incorporating item-, store-, and vendor-based features; and based on the validation methodology, choose the optimal lead time prediction. In some implementations, the lead time variability generator 324 is configured to analyze the historical lead time data to determine the estimated actual lead time value with respect to the product based on: a probabilistic model comprising weighted kernel density, log curve, polynomial curve, univariate spline, cubic spline, and gaussian curve, and/or a machine learning random forest model. In addition, the lead time variability generator 324 may be configured to select the estimated actual lead time value derived via the probabilistic model or the estimated actual lead time value derived via the machine learning random forest model (i.e., best model selection) based on estimated accuracy of the selected model.

In some aspects, the lead time variability generator 324 is configured to use the lead time generation script to get the observed lead time for Channels (1, 4, 5) at a store level along with the system lead time. This data set may include vendor- and product-related data. On some approach, the data is analyzed in parallel over a given time interval (e.g., 90 days preceding today's data over the current year plus the two years prior). The lead time variability generator 324 may weigh the lead times as per a sigmoid curve for recency (filtering for the item stores that were active for at least 30 days in the preceding 90 days) and exclude any data which does not have the lead time recorded. In some aspects, as a part of the exploratory data analysis, the control unit 210 analyzes metrics such as missing values, spread of the system and actual lead time, and for lead time, data is captured at an integer time level only and not on a more granular level. In some approaches, an exponential weightage strategy is used by using the sigmoid function to weigh in the lead times based on the time of occurrence.

In some embodiments, the lead time variability generator 324 is configured to utilize the machine learning—random forest approach, which is based on lead time data indicative of features/attributes including, but not limited to: past delivery delays for the product, vendor-based attributes, weather conditions, seasonal time of the year, product-based attributes, production delays, material defects, and store-based attributes (location, capacity etc.). In certain implementations, these features are prepared/analyzed by the lead time variability generator 324 based on the availability and importance of this exemplary feature set, and the random forest algorithm has been found to provide good predicted lead time results.

In some embodiments, the lead time variability generator 324 is configured to utilize the probabilistic approach, which is based on fitting complex curves to suit the actual distribution of lead time and taking a confidence based cut off to determine this predicted lead time. In some aspects, various methods for the curves (e.g. kernel density, polynomial etc.) are modified from the traditional way of fitting distribution data based on frequency alone, since the lead time variability generator 324 uses the weightage of each point as calculated previously. The lead time variability generator 324 may also be programmed to select the best technique/algorithm between the machine learning and probabilistic approaches in order to predict the lead time.

In some embodiments, in order to perform a selection of the best model (e.g., probabilistic or machine learning), the lead time variability generator 324 is configured to consider a train test approach using the latest lead time as the test data and calculate the various metrics (such as mean absolute percentage error (MAPE), Early/On-Time (EOT), On-Time (OT), etc.) at a category level. In some approaches, the lead time variability generator 324 uses EOT, which is based on the number of days delay compared to the stipulated lead time. This metric facilitates making the decision regarding the lead time prediction best model (i.e., machine learning or probabilistic) related to safety stock values as compared to conventional ways to analyze errors. In one approach, the lead time variability generator 324 uses a voting-based mechanism to select the optimal prediction method (i.e., machine learning or probabilistic) based on the highest number of votes (wins) using this EOT metric along with other errors for the particular category. A voting-based mechanism then selects the based method based on the highest no of votes (wins) for the particular category. This voting table can be refreshed periodically (e.g., every quarter) and the resultant table is consumed in every run.

Generally, the lead time variability generator 324 attempts to determine a probabilistic view of the actual lead time in order to fit the most accurate lead time variation to be observed in near future. In some approaches, this includes analyzing variations of fitting a curve to existing data points using a parametric, non-parametric distribution (density estimator) and best fit spline. The intent is to fit the best fit curve and then use the area under the curve (AUC) as a confidence cut off level. For items with few data points (e.g., less than 5), the lead time variability generator 324 may be configured to use a simple average/weighted average approach.

In certain embodiments (see, e.g., FIG. 3), the computing device 120 may include or be coupled to a lead time augmentation module 347 that is configured to analyze the historical lead time data stored in the electronic database 140 in association with the product being analyzed for stock safety calculation purposes. As mentioned above, in some implementations, the lead time augmentation module 347 may be a part of the data aggregation system. In some aspects, in response to a determination by the lead time augmentation module 347 that the electronic database 140 does not store a threshold level of the historical lead time data in association with the product, the lead time augmentation module 347 is configured to generate estimated lead time data in association with the product. The lead time data in association with the product may be estimated by the lead time augmentation module 347 based on analysis by the lead time augmentation module 347 of historical lead time data associated with products similar to the analyzed product and/or analysis by the lead time augmentation module 347 of historical lead time data associated with products supplied by a supplier that supplied the analyzed product to the retail facility 110.

In some embodiments, the lead time data is analyzed and prepared in a parallel manner across time periods rather than analyzing the lead time data in a linear time series view (e.g. January 2018-January 2020). Then, based on this new view of the lead time data, a weightage is assigned to these lead time data points using a self-defined exponential weightage strategy. It is not uncommon for products to have very few actual lead time data points captured. Thus, the lead time augmentation module 347 is configured to find similar products and look at a recent supplier-based lead time data to augment the missing information. One of the features that the lead time augmentation module 347 may analyze is the supplier/vendor-based shipment delay times. This approach helps to find lead times for new products being shipped to the retail facility 110.

In an exemplary kernel density-based approach, a kernel density estimator shown below is used with a weighted variation (here, K is the kernel—a nonnegative function, and a range of kernel functions are commonly used: uniform, triangular, bi-weight, tri-weight, Epanechnikov, normal, and others):

$${\hat{f}}_{h} ( x ) = \frac{1}{n} {\sum }_{i = 1}^{n} {K}_{h} ( x - {x}_{i} ) = \frac{1}{nh} {\sum }_{i = 1}^{n} K ( \frac{x - {x}_{i}}{h} ) , \\ Kernel Density Estimator$$

$$\hat{f} ( x ) = {\sum }_{i = 1}^{n} w ( {X}_{i} , {Z}_{i} ) {K}_{h} ( x - {X}_{i} ) , \\ Weighted kernel Density estimator$$

z: Covariate(s), K: Kernel (Gaussian), h: bandwidth

With reference to the formula above, h>0 is a smoothing parameter called the bandwidth (h) which acts like a regulator. In order to choose the bandwidth, techniques like Scott's and/or Silverman may be used. Choosing h is critical in density estimation. In particular, a large h will over smooth the density estimator (DE) and mask the structure of the data, whereas a small h will yield a DE that is sharp and very hard to construe. The choice of the bandwidth factor also greatly affects the curve fit, and a range of techniques may be used, ranging from static formulas such as Scott's/Silverman to more robust approaches such as cross validation and grid search, though the use of the latter will greatly depend on the sample size and type of prediction. In certain implementations, other approaches such as empirical probability mass estimate, fitting of univariate splines may be employed to determine best lead time estimates.

In some embodiments, the lead time variability generator 324 is configured to use the observed lead time distribution for each items/tore to fit a complex polynomial function depicted below:

a₀+a₁x+a₂x²+ . . . +aₙxⁿ

In some approaches, the lead time variability generator 324 may also fit the distribution based on Gaussian, logistic and univariate and cubic spline functions and observe the R-squared and RMSE values. In an attempt to avoid picking a function that immediately overfits, the lead time variability generator 324 may be configured to choose the requisite function to be used for the curve based on the R square (>70%) and RMSE values, and then to calculate the requisite lead time to ensure the AUC falls within the cut off probability (e.g., 80%). Then, the lead time variability generator 324 only looks at calculated values which are less than Cantelli's inequality value for the same probability and then take the median of these values.

In some approaches, the lead time variability generator 324 analyzes fitting a particular parametric distribution (based on the industry knowledge) to learn the best parameters for such a distribution using maximum likelihood estimation (MLE) based on availability of requisite data points. For example, in one approach, the lead time variability generator 324 analyzes the Shapiro-Wilk and/or Kolmogorov-Smirnov Goodness of Fit Test to check if the data comes from a normal or gamma distribution, respectively. For example, for Shapiro-Wilk, the null hypothesis may be that the population is normally distributed. For Kolmogorov-Smirnov, the null hypotheses for the test are: (H0): the data comes from the specified distribution and (H1): at least one value does not match the specified distribution. These methods are considered an ensemble based on which the applicable method will be picked based on parameters such as data points count, and attributes such as lead time variability, sales velocity etc. In cases where very few data points have been observed, the above processes may be carried at a supplier level. Thus, looking at a probabilistic cut off for the lead time, the safety stock calculation may be fine-tuned for each product, and would also allow the user to choose a cut-off based on the cumulative probability (e.g., Product A would take 12 days lead time with probability of 90%).

In certain situations, various products may have very few actual lead time data points associated therewith. In order to counteract this issue, in some approaches, the lead time variability generator 324 is configured to analyze at the supplier and observe the actual lead time for all of the products serviced by this supplier. A challenge with this approach is that the system lead times for the various items should be very similar and also only the recent data should be analyzed, since the supplier for the product could have changed in quality and volume over time. In some situations, the lead time variability generator 324 can also assess whether the lead times associated with a given supplier follow a pattern or not. For example, since products may come from different suppliers over time, supplier level categorization offers a granularity of information that may not be found through the product hierarchies. In addition, lead time can also be modelled from a supplier reliability or risk perspective, and a supplier reliability index could be programmed into the lead time variability generator 324 as a parameter in the lead time calculation. For example, a supplier A with 5 days lead time but higher confidence may be preferred over Supplier B with 4 days lead time but less confidence.

In some approaches, the lead time variability generator 324 uses a predictive machine learning approach for lead time determination using multiple features. For example, the lead time variability generator 324 may use a linear mix modelling (LMM) approach to predict the lead time at a store level although the model would run at a national level. Here, the lead time variability generator 324 would account for the features as fixed or random for the model development. Such an approach may be useful because it allows the use of the learnings of the complete data rather than running individual models at an item level for which there may be very few data points. In addition, as mentioned above, the lead time variability generator 324 may utilize other machine learning algorithms such as random forest.

In certain approaches, the lead time variability generator 324 is configured to calculate lead time at a point in time based on features such as: past delivery delays, vendor-based weather conditions, seasonal time of the year, product-based production delays, material defects (e.g., defect rate in each order), store-based weather conditions, etc. Hence, the lead time variability generator 324 analyzes features relating to availability and importance using the random forest approach, which has been found to produce good results. In certain aspects, once the predicted lead time at a point in time is known, the lead time variability generator 324 can estimate the demand during this lead time (which then facilitates an optimization for safety stock using the safety stock calculation by the safety stock generator 326). This eventually removes the excess inventory needed to balance for the lead time variance aspect of safety stock.

In the exemplary embodiment shown in FIG. 3, the computing device 120 also includes or is coupled to a safety stock generator 326. The safety stock generator 326 is configured to correlate the estimated demand variability value and the estimated actual lead time value to determine an estimated safety stock value with respect to the product. The demand variability generator 322, the lead time variability generator 324 and the safety stock generator 326 may be configured to run on a python or another suitable platform. In some aspects, the safety stock generator 326 uses the predicted lead time (predicted by the lead time variability generator 324) and the standard deviation of the predicted demand forecast error (predicted by the demand variability generator 322) to calculate the safety stock for given product for a given store for a given day. In one exemplary approach, the safety stock generator 326 is programmed to calculate safety stock using the formula safety stock=z score*square rood of predicted lead time (LT)* standard deviation of demand (σD), also reproduced below:

Safety stock=Z×\sqrt{PC/T,}×σ_{D}
PC=performance cycle (total lead time)
T₁=time used for calculating SD of demand
σ_{D}=SD of demand
Z=Service Level

Here, a machine learning algorithm is used to model the forecast error (i.e., Demand—Forecast), which could then be used to calculate the estimated demand variation. Various algorithms may be tested via the demand variability generator 322, for example, prophet, long short-term memory (LSTM—based time series prediction, ARIMA, Bayesian structural time series (BSTS) etc. Generally, the intent is that the global replenishment system (GRS) forecast would already capture the high level seasonal and promotional effects but the intent is also to capture local factors such as a store planned promotion, weather changes for the next few days which will help boost the demand variations which might occur in the near future, thus facilitating the fine-tuning of the demand variation component. Ideally, if the GRS forecast is accurate, then the forecast errors should be very random and hence past demand and forecast may be used for calculating the demand variability (with factors being promotion, seasonality, etc.)

In some approaches, the demand variability generator 322 is configured to calculate the standard deviation between sales and the forecast using the formula below:

$$σ = \sqrt{\frac{\sum Deviation squared}{N - 1}}$$

In certain aspects, the demand variability generator 322 is configured to use an exponential smoothening-based technique to capture the one lead time period ahead of forecast error deviation. Within this period, the Mean Squared Error (Demand—Forecast) can be forecasted for the lead time period and also the Standard deviation. The forecast calculation is represented by the formula below:

Fₜ=Fₜ₋₁+α(Aₜ₋₁−Fₜ₋₁)
where: Fₜ=new forecast
   Fₜ₋₁=previous period forecast
   Aₜ₋₁=previous period actual demand
   α=smoothing (weighting) constant

In some embodiments (e.g., FIG. 3), the computing device 120 may also include or be coupled to a service level correction module 343. The service level correction module 343 may be configured to adjust the estimated safety stock value and generate a final safety stock value with respect to the product based on the actual demand distribution data obtained by the service level correction module 343 from the electronic database 140. As mentioned above, in some embodiments, the safety stock calculation is performed by the safety stock generator 326 on a normal curve assumption (though in reality this is rarely the case), and hence the service level correction module 343 is programmed to correct for this assumption by learning the fit of the actual demand distribution data.

In some aspects, the service level correction module 343 is configured to compute the mean and standard deviation of the observed historical demand data, and overlay a curve showing the probability density function (PDF) of a normal distribution with this same mean and standard deviation. The service level adjustment approach may simply use the Normal method, but increase the target service level parameter to be equal to a cumulative distribution function value that would achieve no more than 5% stockout level. Based on this, the service level correction module 343 is programmed to change the set customer service level to the actual level as obtained based on the actual demand distribution. In one example, based on this correction by the service level correction module 343, the z score value of service level may be increased to 97% instead of 95% to achieve the same 5% stock-out level. In certain implementations, the safety stock workflow is set to run daily and populate the safety stock values for all products at the retail facility 110 on a daily basis.

The effectiveness of the safety stock calculation by the system 100 described above can be measured in terms of minimizing the Lost Sales Due to out of style (OOS) and Inventory Holding Cost due to holding of excess safety stock inventory. For example, the formula that may be used is Cost=Lost Sales due to OOS+Cost due to Excess inventory. Using this formula, the safety stock calculation by the system 100 was determined to result in significant overall (and per product) savings to a sample of 12 retail facilities over a period of 10 days.

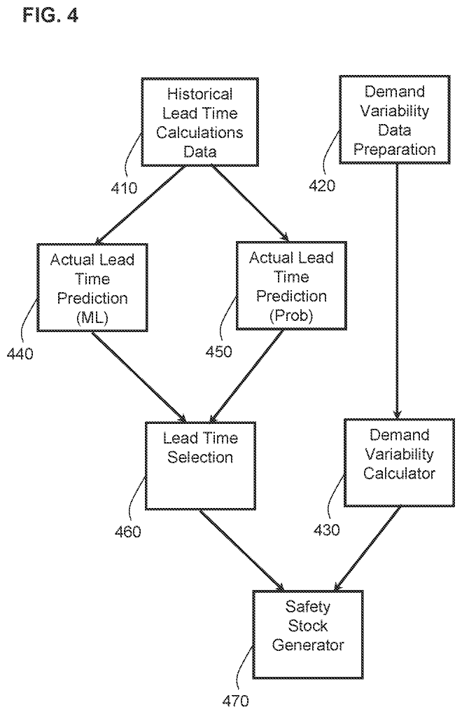

An overview of an exemplary workflow associated with the generators 322, 324, and 326 in calculating the safety stock for a given product is depicted in FIG. 4. With reference to FIG. 4, the lead time variability generator 324 obtains historical lead time calculations data from the electronic database 140 (step 410) while the demand variability generator 322 obtains (e.g., from the electronic database 140) and/or prepares the demand variability data (step 420). The demand variability generator 322 then utilizes its demand variability calculator function (step 430) in order to calculate demand variability based on the obtained/prepared demand variability data. On the other hand, the lead time variability generator 324 generates an actual lead time based on either the machine learning approach (step 440) or probabilistic approach (step 450). Then, the lead time variability generator 324 estimates which of the two approaches generate a more accurate result and selects this result (step 460). Finally, the output of the demand variability generator 322 and the output of the lead time variability generator 324 is fed to the safety stock generator 326, which processes the received outputs and calculates the safety stock value for the product at the retail facility 110 (step 470).

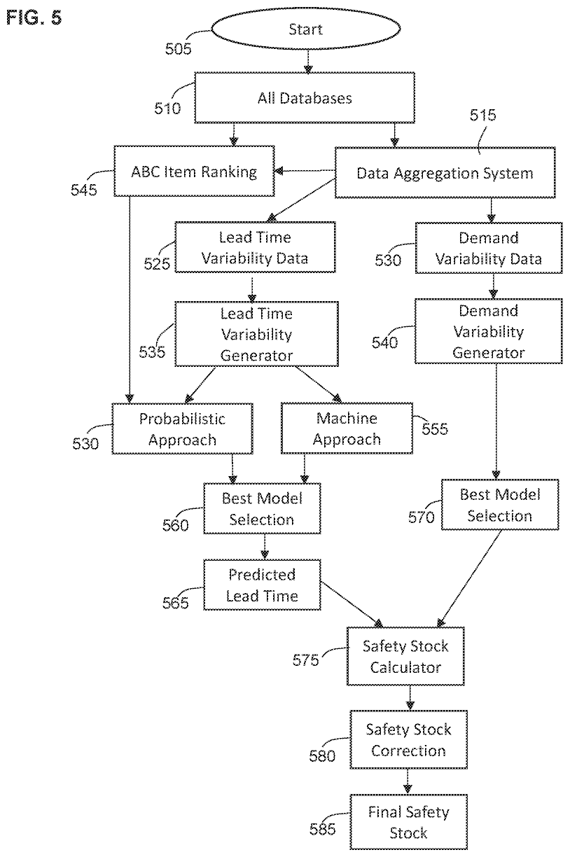

A more detailed exemplary workflow of the system 100 is depicted in FIG. 5. In some aspects, such workflow would run at a daily level and show the safety stock for the product for a retail store for the next day, which can be projected for the week. Similar workflow may be for a product distribution warehouse instead of the retail store. With reference to FIG. 5, at the start of the workflow (step 505), a compound set of data stored in the electronic database 140 (step 510) is obtained by a data aggregation system (which, as mentioned above, may include the lead time augmentation module 347) obtains a compound set of data from the electronic database 140 (step 515). Then, the data obtained by the data aggregation system is processed to create (1) lead time variability data (also referred to herein as Table A data set) (step 525) that goes into and is processed by the lead time variability generator 324 (step 535); and (2) demand variability data (also referred to herein as Table B data set) (step 530) that goes into and is processed by the demand variability generator 322 (step 540).

In certain aspects, the control unit 210 of the computing device 120 is programmed to create an ABC classification of products based on the system lead time and sales ranking (step 545), and hence the output will be the product number and rank. Here, the ABC classification method is used to rank order the importance of the products for safety stock confidence interval based on some parameters such as product sales and historical lead time. For example, this data may be broken into percentiles and a rank may be assigned for same. This rank will then be used in further model building techniques. As such, a product that is important would be associated with the highest confidence level in terms of the safety stock values in order to increase the probability that this important product will not have any stock outages.

In some approaches, for product sales, the system lead time is initially broken into 5 percentile groups (highest being first) based on rank ordering for the store category combination. Then, the control unit 210 assigns an average percentile rank being on weightage to sales and lead time (e.g., 70%-30% ratio), and then again assigns rank order into 4 percentile groups. Then, the highest percentile group (A) gets a confidence cut of 90%, B 85%, and so forth, and once the products are classified per class, the corresponding probability for the calculated lead time is selected (e.g., if the selected product is in class A, it has high sales and higher lead time). In some aspects, the control unit 210 is programmed to analyze product velocity instead of product sales.

In some aspects, this output is used for allocating the required confidence interval for the lead time probabilistic approach (step 550). The control unit 210 may be programmed to identify products which are newly introduced at the retail facility 110 and for which lead time data is not present, and hence the lead time augmentation module 347 will be used. In some aspects, the control unit 210 is programmed to use the capping and flooring technique to exclude any lead time days and product sales which look to be erroneous (e.g. 3000 days lead time or negative lead time). In some aspects, the control unit 210 is programmed to apply weight to the lead times by looking at seasonality and recency effect based on a sigmoid curve equation, and output a column of weight. In some approaches, the control unit 210 is programmed to identify seasonality by taking the monthly sales percentage for a product and calculating the coefficient of variation. If the product is determined to be a seasonal item, in some aspects, the control unit 210 increases service level before the season or adds an additional product safety stock bandwidth. In certain aspects, the control unit 210 is programmed to augment the missing data by looking at similar vendor and product type, hence initially a product may have, for example, 2 rows of table A data but post-augmentation may have 10-15 rows data.

In some aspects, the Table A lead time variability data input into the lead time variability generator 324 in step 535 includes, but is not limited to, the product identification number (e.g., SKU or other identifier), ship to store number, order invoice date, invoice number, supplier number, order date, shipment quality, actual lead time days (e.g., the recorded actual lead time from supplier or distribution center to the retail facility 110), department description, category description, lead time record weight, system defined lead time, etc. On the other hand, the Table B demand variability data input into the demand variability generator 322 in step 540 may include, but is not limited to, product sale date, product identification number, store Number, sales (in $), quantity, forecast quantity (forecast quantity on a given date), customer service level, etc.

In certain embodiments, the lead time generator 324, based on a lead time variability data set representing table A, is configured to generate to sub-outputs based on the calculation approach used. In particular, if the probabilistic approach is used (step 550), the lead time variability generator 324 outputs data including: predicted lead time, product number, store number, confidence level (multiple rows with predicted lead time based on the confidence % of the arrive to arrive), error variance based on items arriving early/on time or late, root mean squared error (RMSE) and mean absolute percentage error (MAPE) using train and test split based on historical data evidence. Here, the desired confidence level for a product can be selected based on the ABC classification table mentioned above (and for a confidence level of, for example 85%, a single row may be selected from this table which then becomes the predicted lead time.

If the machine learning approach is used (step 555), the lead time variability generator 324 outputs data including: predicted lead time, product number, store number, and error based on products arriving early/on time or late, RMSE & MAPE using train and test split based on historical data evidence. Based on the above two models now, using a voting technique on the errors, the lead time variability generator 324 chooses the best model (step 560), and generates the predicted lead time for the product number at the level of the retail facility 110 (step 565).

In some embodiments, the demand variability generator 322, based on a demand variability data set representing input table B, is configured to generate an output that includes the product number, the predicted standard deviation of the demand for the next lead time period (in terms of units), and the customer service level. The demand variability generator 322 then chooses the best model and generates the predicted demand variability for the product number at the level of the retail facility 110 (step 570).

With reference to FIG. 5, the outputs of the demand variability generator 322 and the lead time variability generator 324 are input into the stock safety generator 326 (step 575), and the safety stock generator 326 is configured to output the product number, store number, and safety stock (in units) with respect to the analyzed product. Then, the service level correction module 343 receives the output of the safety stock generator 326 and output the product number, the store number, and the safety stock (in units) (step 580), which then represents the final safety stock value with respect to the product at the retail facility 110 (step 585).

In some embodiments, the final safety stock value along with the inventory levels (i.e., information obtained from the electronic database 140) is displayed within the graphical interface 135 generated on the display 125 of the computing device 120. In some embodiments, the graphical interface 135 that displays the final safety stock value is in the form of a graphical user dashboard. The graphical user dashboard/simulation tool may be built in RShiny. Users of the computing device 120 that may have access to the graphical interface 135 may include but are not limited to manager(s) of the retail facility 110, product replenishment managers, forecasting system users, developers, and vendors, Category Managers, third party users associated with distribution center/retail facility operations, and the like.

In some aspects, the graphical interface/simulation display tool 135 shows how the daily inventory varies during a given time frame based on the demand pattern, order cycle and safety stock setting as per the chart. The user of the computing device 120 can change the safety stock values based on further suggestions of imminent promotions, which are made based on the system 100 learning the effect of custom promotions based on historical evidence of the custom promotions. A feedback loop using the new suggestions (e.g., made by the user) may be used to re-calculate the safety stock using the item variability forecasting system. In some aspects, the graphical interface/simulation display tool 135 outputs an inventory simulation that is run 1000 times (taking into account the inventory level, demand, lost sales, order information, and safety stock), and the average loss of revenue is shown in terms of lost sales and excess inventory. In some implementations, a dollar value pertaining to the lost sales (i.e., unfulfilled demand for the day) and excess inventory (i.e., excess inventory compared to a defined threshold level) is also displayed to the user within the graphical interface/simulation display tool 135, and this display helps the user measure the efficacy of the safety stock values.

In some aspects, the graphical interface/simulation display tool 135 may further include a graphic (e.g., a menu or sub-menu) indicating an actual accuracy of the final safety stock value and one or more input fields that permit the user of the computing device 120 to vary at least one parameter used to determine the final safety stock value. In certain implementations, the system 100 includes a feedback loop from the graphical interface/simulation display tool 135 to permit the demand variability generator 322, the lead time variability generator 324, and the safety stock generator 326 to determine an updated estimated safety stock value with respect to one or more products based on one or more parameter values varied by the user within the graphical interface/simulation display tool 135.

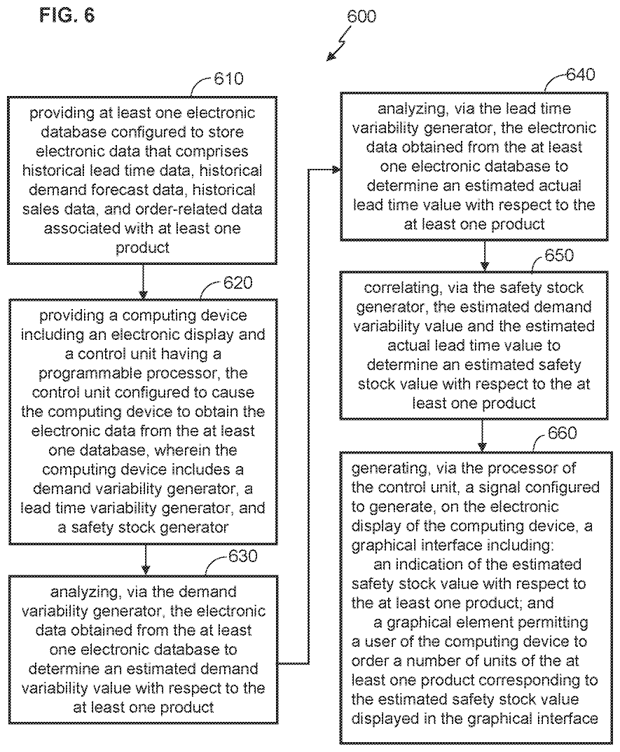

With reference to FIG. 6, one method 600 of operation of the system 100 to calculate a safety stock of at least one product at a retail facility to reduce out-of-stock events for one or more products at the retail facility 110 is shown. For exemplary purposes, the method is described in the context of the system of FIG. 1, but it is understood that embodiments of the method may be implemented in this or other systems.

As shown in FIG. 6, the method 600 includes providing at least one electronic database 140 configured to store electronic data that comprises historical lead time data, historical demand forecast data, historical sales data, and order-related data associated with one or more products that is being analyzed for safety stock purposes (step 610). The method 600 also includes providing a computing device 120 including an electronic display 125, a control unit 210 having a programmable processor, a demand variability generator 322, a lead time variability generator 324, and a safety stock generator 326, and where the control unit 210 is configured to cause the computing device 120 to obtain the electronic data from the electronic database 140 (step 620).

In the exemplary embodiment shown in FIG. 6, the method 600 further includes analyzing, via the demand variability generator 322, the electronic data obtained from one or more electronic databases 140 to determine an estimated demand variability value with respect to the one or more products being analyzed for safety stock purposes (step 630). As mentioned above, the demand variability generator 322 is configured to obtain the historical product forecast data and the historical product sales data from the electronic database 140, and to calculate/estimate the demand forecast error. In certain aspects, when calculating the demand forecast error, the demand variability generator 322 is configured to take into account other external factors (which may be input by various users via various tools). As also mentioned above, the demand variability generator 322 analyzes the historical demand forecast data to determine the estimated demand variability value with respect to the product based on a simple exponential smoothing model and/or an ARIMA model. In addition, in certain aspects, the demand variability generator 322 selects the model (e.g., simple exponential smoothing model or ARIMA) estimated to be the best (i.e., associated with the lowest estimated error value).

In the exemplary embodiment shown in FIG. 6, the method 600 further includes analyzing, via the lead time variability generator 324, the electronic data obtained from one or more electronic databases 140 to determine an estimated actual lead time value with respect to the one or more products being analyzed for safety stock purposes (step 640). As discussed above, the lead time variability generator 324 is configured to obtain and/or augment supplier-based lead times and obtain the historical product lead time distribution and apply an exponential weightage strategy to these values. As mentioned above, the lead time variability generator 324 may analyze the historical lead time data to determine the estimated actual lead time value with respect to the product based on: a probabilistic model comprising weighted kernel density, log curve, polynomial curve, univariate spline, cubic spline, and gaussian curve, and/or a machine learning random forest model. In addition, in some aspects, the lead time variability generator 324 may select the estimated actual lead time value derived via the probabilistic model or the estimated demand variability value derived via the machine learning random forest model (i.e., best model selection) based on estimated accuracy of the selected model.

As mentioned above, the safety stock generator 326 correlates the estimated demand variability value and the estimated actual lead time value to determine an estimated safety stock value with respect to the product. To that end, with reference to FIG. 6, the method 600 further includes correlating, via the safety stock generator 326, the estimated demand variability value and the estimated actual lead time value to determine an estimated safety stock value with respect to the one or more products being analyzed for safety stock purposes (step 650). As discussed above, the safety stock generator 326 may be programmed to use the predicted lead time (predicted by the lead time variability generator 324) and the standard deviation of the predicted demand forecast error (predicted by the demand variability generator 322) to calculate the safety stock for given product for a given store for a given day using the following formula: safety stock=z score*square root of predicted lead time (LT)*standard deviation of demand (σD). The standard deviation of demand component will be derived from the predicted demand forecast error.

In certain implementations, the method 600 may further include adjusting, via a service level correction module 343, the estimated safety stock value generated by the safety stock generator 322, and generating a final safety stock value with respect to the product based on the actual demand distribution data obtained by the service level correction module 343 from the electronic database 140. As mentioned above, in some embodiments, the service level correction module 343 is programmed to correct for the (often imprecise) normal curve assumption by learning the fit of the actual demand distribution data, and change the set customer service level to the actual level as obtained based on the actual demand distribution.

After the safety stock generator calculates the safety stock value for the product being analyzed, the safety stock value (which may be adjusted by the service level correction module 343 as discussed above) is displayed to the user on the display 125 of the computing device 120. To that end, the method 600 further includes generating, via the processor of the control unit 210, a signal configured to generate, on the electronic display 125 of the computing device 120, a graphical interface 135 that includes an indication of the estimated safety stock value with respect to the product, and a graphical element permitting a user of the computing device 120 to order a number of units of the product corresponding to the estimated safety stock value displayed in the graphical interface 135 (step 460).

As mentioned above, the graphical interface 135 may be configured to show how the daily inventory varies during a given time frame based on the demand pattern, order cycle and safety stock setting as per the chart, and the user of the computing device 120 can change the safety stock values and various other parameters based on various factors (e.g., product features/promotions/seasonal sales, etc.). In some implementations a feedback loop is activated in response to the modifications made by the user, and this feedback loop facilitates the re-calculation of the safety stock value based on the user modifications.

The systems and methods described herein provide for various approaches/algorithms to learn and predict the lead time dynamically (compared to the conventional way of using a statistical technique), and this calculated lead time is then used to estimate the demand variability. The reliability of the demand variability prediction is enhanced by using a time series-based prediction to estimate the forecast for a lead time period into the future. The lead time prediction can be made by learning the actual distribution of the historical lead times using complex fitting curves and using a machine learning algorithm based on various features. The demand variability prediction can be made by using an exponential smoothening technique to predict the demand variability one lead time period into the feature. As a result, the present invention is a dynamic, future-focused approach which improves the safety stock values and leads to a reduction in out of stock situations and/or excess inventory.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system for calculating a safety stock of at least one product at a retail facility to reduce out-of-stock events for the at least one product at the retail facility, the system comprising:
at least one electronic database configured to store electronic data that comprises historical lead time data associated with the at least one product, historical demand forecast data associated with the at least one product, historical sales data associated with the at least one product, and order-related data associated with the at least one product;
a computing device including an electronic display and a control unit having a programmable processor, the control unit configured to cause the computing device to obtain the electronic data from the at least one database,
wherein the computing device includes:
a demand variability generator configured to analyze the electronic data obtained from the at least one electronic database to determine an estimated demand variability value with respect to the at least one product;
a lead time variability generator configured to analyze the electronic data obtained from the at least one electronic database to determine an estimated actual lead time value with respect to the at least one product; and
a safety stock generator configured to correlate the estimated demand variability value and the estimated actual lead time value to determine an estimated safety stock value with respect to the at least one product; and
wherein the processor of the control unit is programmed to generate a signal configured to generate, on the electronic display of the computing device, a graphical interface including:
an indication of the estimated safety stock value with respect to the at least one product; and
a graphical element permitting a user of the computing device to order a number of units of the at least one product corresponding to the estimated safety stock value displayed in the graphical interface.

2. The system of claim 1, further comprising a lead time augmentation module configured to:
analyze the historical lead time data stored in the at least one database in association with the at least one product; and
in response to a determination by the lead time augmentation module that the at least one database does not store a threshold level of the historical lead time data in association with the at least one product, generate estimated lead time data in association with the at least one product based on at least one of:
analysis, by the lead time augmentation module, of historical lead time data associated with products similar to the at least one product; and
analysis, by the lead time augmentation module, of historical lead time data associated with products supplied by a supplier that supplied the at least one product to the retail facility.

3. The system of claim 1, wherein:
the demand variability generator is configured to transmit the determined estimated demand variability value with respect to the at least one product to the at least one database;
the lead time variability generator is configured to transmit the determined estimated actual lead time with respect to the at least one product to the at least one database; and
the safety stock generator is configured to obtain the estimated demand variability value and the estimated actual lead time from the at least one database.

4. The system of claim 1, wherein the lead time variability generator is configured to:
analyze the historical lead time data to determine the estimated actual lead time value with respect to the at least one product based on at least one of a probabilistic model comprising weighted kernel density, log curve, polynomial curve, univariate spline, cubic spline, and gaussian curve, and a machine learning random forest model; and
select the estimated actual lead time value derived via the probabilistic model or the estimated demand variability value derived via the machine learning random forest model based on estimated accuracy of the selected model.

5. The system of claim 1, wherein the demand variability generator is configured to correlate the historical demand forecast data associated with the at least one product and the historical sales data associated with the at least one product, and to estimate a demand forecast error associated with the at least one product.

6. The system of claim 1, wherein the demand variability generator is configured to:
analyze the historical demand forecast data to determine the estimated demand variability value with respect to the at least one product based on at least one of a simple exponential smoothing model and an autoregressive integrated moving average (ARIMA) model; and
select the estimated demand variability value derived via the simple exponential smoothing model or the estimated demand variability value derived via the autoregressive integrated moving average (ARIMA) model based on estimated accuracy of the selected model.

7. The system of claim 1,
wherein the at least one database further includes actual demand distribution data; and
further comprising a service level correction module configured to adjust the estimated safety stock value and generate a final safety stock value with respect to the at least one product based on the actual demand distribution data obtained by the service level correction module from the at least one database.

8. The system of claim 7, where the graphical interface further includes an indication of the final safety stock value with respect to the at least one product.

9. The system of claim 8, wherein the graphical interface further includes a display simulation dashboard including a graphical output indicating an actual accuracy of the final safety stock value and at least one input field configured to permit the user of the computing device to vary at least one parameter used to determine the final safety stock value.

10. The system of claim 9, further comprising a feedback loop from the display simulation dashboard to permit the demand variability generator, the lead time variability generator, and the safety stock generator to determine an updated estimated safety stock value with respect to the at least one product based on the at least one parameter value varied by the user within the display simulation dashboard.

11. A method of calculating a safety stock of at least one product at a retail facility to reduce out-of-stock events and build-up of excess inventory for the at least one product at the retail facility, the system comprising:
providing at least one electronic database configured to store electronic data that comprises historical lead time data associated with the at least one product, historical demand forecast data associated with the at least one product, historical sales data associated with the at least one product, and order-related data associated with the at least one product;
providing a computing device including an electronic display and a control unit having a programmable processor, the control unit configured to cause the computing device to obtain the electronic data from the at least one database, wherein the computing device includes a demand variability generator, a lead time variability generator, and a safety stock generator;
analyzing, via the demand variability generator, the electronic data obtained from the at least one electronic database to determine an estimated demand variability value with respect to the at least one product;
analyzing, via the lead time variability generator, the electronic data obtained from the at least one electronic database to determine an estimated actual lead time value with respect to the at least one product; and
correlating, via the safety stock generator, the estimated demand variability value and the estimated actual lead time value to determine an estimated safety stock value with respect to the at least one product; and
generating, via the processor of the control unit, a signal configured to generate, on the electronic display of the computing device, a graphical interface including:
an indication of the estimated safety stock value with respect to the at least one product; and
a graphical element permitting a user of the computing device to order a number of units of the at least one product corresponding to the estimated safety stock value displayed in the graphical interface.

12. The method of claim 11, further comprising:
providing a lead time augmentation module;
analyzing, via the lead time augmentation module, the historical lead time data stored in the at least one database in association with the at least one product; and
in response to a determination by the lead time augmentation module that the at least one database does not store a threshold level of the historical lead time data in association with the at least one product, generating, via the lead time augmentation module, estimated lead time data in association with the at least one product based on at least one of:
analysis, by the lead time augmentation module, of historical lead time data associated with products similar to the at least one product; and
analysis, by the lead time augmentation module, of historical lead time data associated with products supplied by a supplier that supplied the at least one product to the retail facility.

13. The method of claim 11, further comprising:
transmitting, via the demand variability generator, the determined estimated demand variability value with respect to the at least one product to the at least one database;
transmitting, via the lead time variability generator, the determined estimated actual lead time with respect to the at least one product to the at least one database; and
obtaining, via the safety stock generator, the estimated demand variability value and the estimated actual lead time from the at least one database.

14. The method of claim 11, further comprising:
analyzing, via the lead time variability generator, the historical lead time data to determine the estimated actual lead time value with respect to the at least one product based on at least one of a probabilistic model comprising weighted kernel density, log curve, polynomial curve, univariate spline, cubic spline, and gaussian curve, and a machine learning random forest model; and
selecting, via the lead time variability generator, the estimated actual lead time value derived via the probabilistic model or the estimated demand variability value derived via the machine learning random forest model based on estimated accuracy of the selected model.

15. The method of claim 11, further comprising correlating, via the demand variability generator, the historical demand forecast data associated with the at least one product and the historical sales data associated with the at least one product, and to estimate a demand forecast error associated with the at least one product.

16. The method of claim 11, further comprising:
analyzing, via the demand variability generator, the historical demand forecast data to determine the estimated demand variability value with respect to the at least one product based on at least one of a simple exponential smoothing model and an autoregressive integrated moving average (ARIMA) model; and
selecting, via the demand variability generator, the estimated demand variability value derived via the simple exponential smoothing model or the estimated demand variability value derived via the autoregressive integrated moving average (ARIMA) model based on estimated accuracy of the selected model.

17. The method of claim 11, further comprising:
providing the at least one database with actual demand distribution data; and
providing a service level correction module configured to adjust the estimated safety stock value and generate a final safety stock value with respect to the at least one product based on the actual demand distribution data obtained by the service level correction module from the at least one database.

18. The method of claim 17, where the graphical interface further includes an indication of the final safety stock value with respect to the at least one product.

19. The method of claim 18, wherein the graphical interface further includes a display simulation dashboard including a graphical output indicating an actual accuracy of the final safety stock value and at least one input field configured to permit the user of the computing device to vary at least one parameter used to determine the final safety stock value.

20. The method of claim 19, further comprising:
providing a feedback loop from the display simulation dashboard; and
determining, via the demand variability generator, the lead time variability generator, and the safety stock generator, an updated estimated safety stock value with respect to the at least one product based on the at least one parameter value varied by the user within the display simulation dashboard.
